(19) United States
(12) Patent Application Publication
(10) Pub. No.: US 2011/0018652 A1
(43) Pub. Date: Jan. 27, 2011

(54) Multimedia network splitter

(76) Inventors: Chun-Hsien Pan, Tainan City (TW); Hsin-Lung Huang, Guiron Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/458,743

(22) Filed: Jul. 22, 2009

(51) Int. Cl. H01P 5/12

(52) U.S. Cl. 333/125

(57) ABSTRACT

This invention relates to a multimedia network splitter in which a plurality of connection terminals are provided at the outer edge of the housing and a circuit board is provided in the interior of the housing. Corresponding to the connection terminals on the housing, a plurality of radially spaced matching circuits are provided on the circuit board. Each matching circuit is composed of an attenuation circuit in cooperation with a microstrip. Each matching circuit is properly matched on the circuit board. With this structure, after the connection terminals are connected with a plurality of televisions or a variety of digital multimedia equipments by coaxial cables, better flatness of frequency bandwidth and wider extended bandwidth can be obtained during transmission of various signals in upload or download condition such that the signals can be evenly distributed among the networks linked between the terminals in use. Furthermore, the insertion loss, i.e., the attenuation value can be adjusted according to demand, and better return loss feature is obtained so as to reach more stable signal distribution and anti-interference characteristics. Therefore, the convenience in its total availability can be intensified.

### BACKGROUND OF THE INVENTION

1. Field of the Invention

This invention relates to a multimedia network splitter, particularly to a novel multimedia network splitter having better flatness in higher frequency extension during duplex signal transmission such that the insertion loss can be adjusted according to demand, and better return loss feature can be obtained so as to reach more stable signal distribution and anti-interference characteristics, hence the effectiveness in its total implementation is intensified when the multimedia network splitter is used to connect with a plurality of televisions or a variety of digital multimedia equipments.

2. Brief Description of Prior Art

The development of combining digital product with digital multimedia equipment is becoming the future trend of home networking. In addition to the WLAN (wireless local area network), the home network connection technology under developing comprises networking technologies of ultra wide band (UWB), HomePlug and MoCA (Multimedia over Coax Alliance) etc. Among those technologies mentioned above, the networking technology of MoCA is a technology alliance founded by a plurality of cable TV companies, satellite TV companies, network equipment suppliers on January 2004. The MoCA is active to facilitate and promote home networking by coaxial cable for home-use so as to connect TV, digital multimedia equipments together for duplex multimedia file transmission and application services. The goal is to integrate telephone, network, CATV, SMATV (Satellite Master Antenna Television System), and WLAN etc. into a coaxial cable through the networking technologies developed by MoCA so as to further upgrade practical application convenience and effectiveness in daily life of human being.

The above networking technology developed by MoCA can reach expected effectiveness of integrating telephone, network, CATV, SMATV (Satellite Master Antenna Television System), and WLAN etc. into a coaxial cable, however it is found in practical application that various signals transmitted through coaxial cable have selective attenuation in the frequency of its return signal during the duplex signal transmission process, after various signals are inputted into a plurality of televisions or a variety of multimedia equipments connected to the multimedia broadband splitter of user end. In other words, the attenuation value is not the same for different frequency such that the flatness of frequency extending to higher frequency is not that good. This will result in instability of signal distribution and liability to interference. Instability of signal distribution and interference become more apparent especially in mansion where a mass of residents exists and a huge amount of televisions and various digital multimedia equipments are connected therein. Consequently, the application of MoCA is still unsatisfactory and hence improvements are anxiously expected.

In view of the above facts, the inventor of the present invention provides a novel multimedia network splitter according to the improvement conducted on defects of the existing structure, based on his abundant experience of R&D and manufacturing in relevant field so as to attain better performance in practical application.

### SUMMARY OF THE INVENTION

The multimedia network splitter of the present invention is essentially provided with a plurality of connection terminal on the outer edge of a housing and a circuit board is provided in the interior; corresponding to the connection terminals on the housing, a plurality of radially spaced matching circuits being connected to the circuit board, which is composed of attenuation circuits in cooperation with microstrips, each matching circuit being properly matched on the circuit. With this structure, after the connection terminals are connected to a plurality of televisions or a variety of digital multimedia equipments by coaxial cables, better flatness of frequency bandwidth and wider extended bandwidth can be obtained during transmission of various signals in upload or download condition such that the signals can be evenly distributed among the networks linked between the terminals in use. Furthermore, the insertion loss, i.e., the attenuation value can be adjusted according to demand, and better return loss feature is obtained so as to reach more stable signal distribution and anti-interference characteristic. Therefore, the convenience in its total availability is intensified.

### BRIEF DESCRIPTION OF THE DRAWINGS

The present invention will be better understood by referring to the accompanying drawings, wherein:

FIG. 1 is a perspective schematic view showing the appearance of the multimedia network splitter of the present invention.

FIG. 2 is a schematic view showing the structural arrangement of the circuit board of the present invention.

FIG. 3 is a circuit diagram of the multimedia network splitter of the present invention.

FIG. 4 is another circuit diagram of the multimedia network splitter of the present invention

FIG. 5 is another perspective schematic view showing the appearance of the multimedia network splitter of the present invention.

FIG. 6 is a characteristic curve of the present invention by connecting a first connection terminal [Rm1] and a fifth connection terminal [Rm5].

FIG. 7 is a characteristic curve of the present invention by connecting a third connection terminal [Rm3] and a fourth connection terminal [Rm4].

FIG. 8 is a characteristic curve of the present invention by connecting a third connection terminal [Rm3] and a eighth connection terminal [Rm8].

### DETAILED DESCRIPTION OF THE PREFERRED EMBODIMENTS

The objects, the technical contents and the expected effectiveness of the present invention will become more apparent from the detailed description of the preferred embodiment in conjunction with the accompanying drawings.

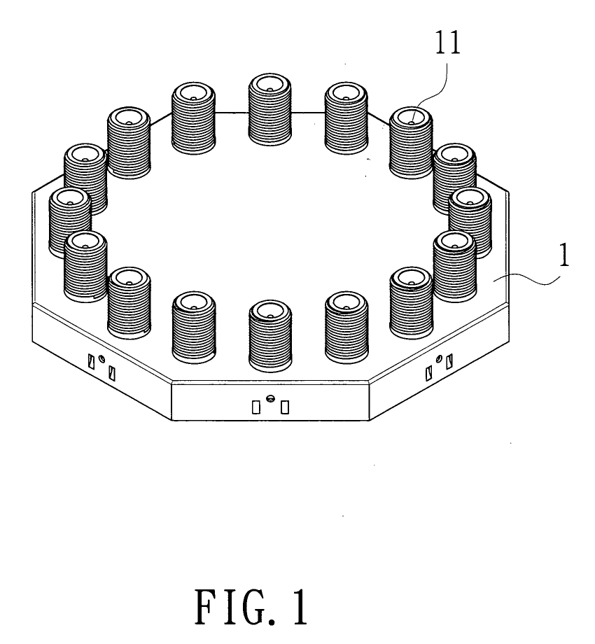

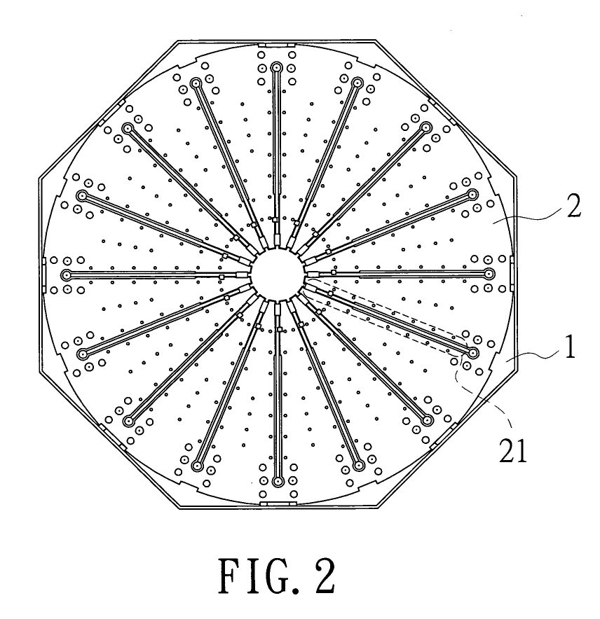

FIG. 1 is a perspective schematic view showing the appearance of the multimedia network splitter of the present invention, and FIG. 2 is a schematic view showing the structural arrangement of the circuit board of the present invention. Firstly referring to FIG. 1, the multimedia network splitter of the present invention comprises a housing (1), a plurality of connection terminals (11) provided at the outer edge of the housing (1) and a circuit board (2) provided in the interior of the housing (1). Corresponding to the connection terminals (11) on the housing (1), a plurality of equally spaced and radially directed matching circuits (21) are provided on the circuit board (2).

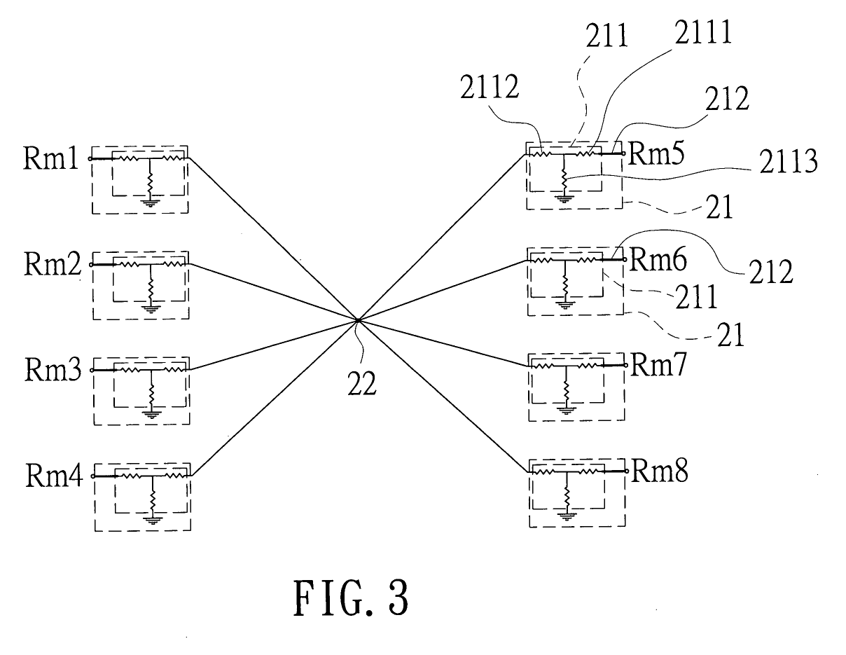

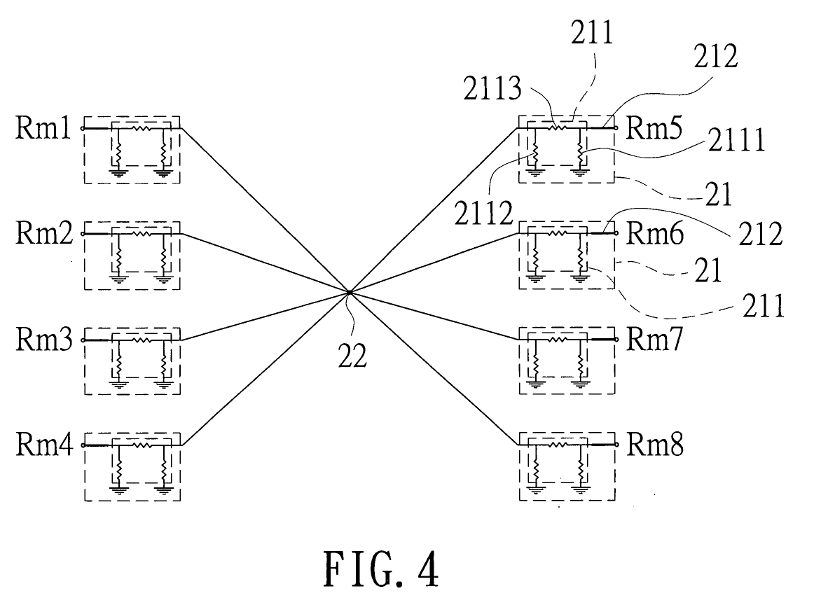

Each matching circuit (21) is composed of an attenuation circuit (211) in cooperation with a microstrip (212). The attenuation circuit (211) is a T shaped attenuation circuit formed by a third resistor (2113) in parallel connection between a first resistor (2111) and a second resistor (2112) both in horizontal arrangement, referring to FIG. 3 showing the circuit diagram of the present invention. Alternatively, the attenuation circuit (211) can be a π shaped attenuation circuit formed by a third resistor (2113) in connection between the first resistor (2111) and a second resistor (2112) both in vertical arrangement, referring to FIG. 4 showing another circuit diagram of the present invention. One end of each matching circuit (21) is connected to one connection terminal (11) on the housing (1), and the other end is connected with the other attenuation circuit (211) together to the center node (22) of the circuit board (2). Each matching circuit (21) is to be properly matched on the circuit board (2).

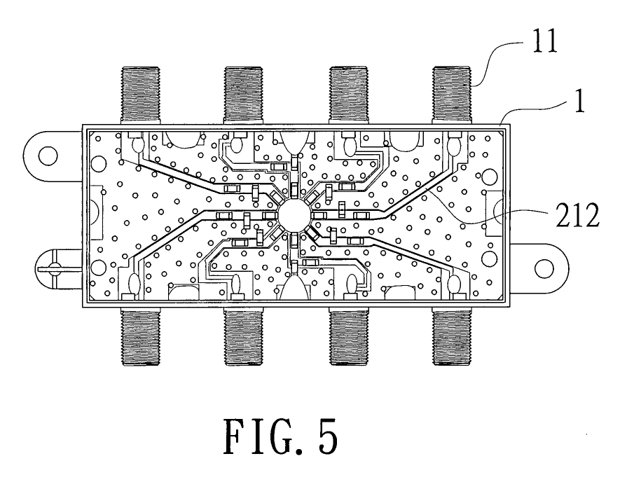

The housing (1) is an octagonal design, and each connection terminal (11) is disposed on the upper end surface of the housing (1), as shown in FIG. 1. Alternatively, the housing (1) can be rectangular, and each connection terminal (11) is disposed on the outside end surfaces, referring to FIG. 5 showing a perspective structural schematic view of the outline of another embodiment of the present invention.

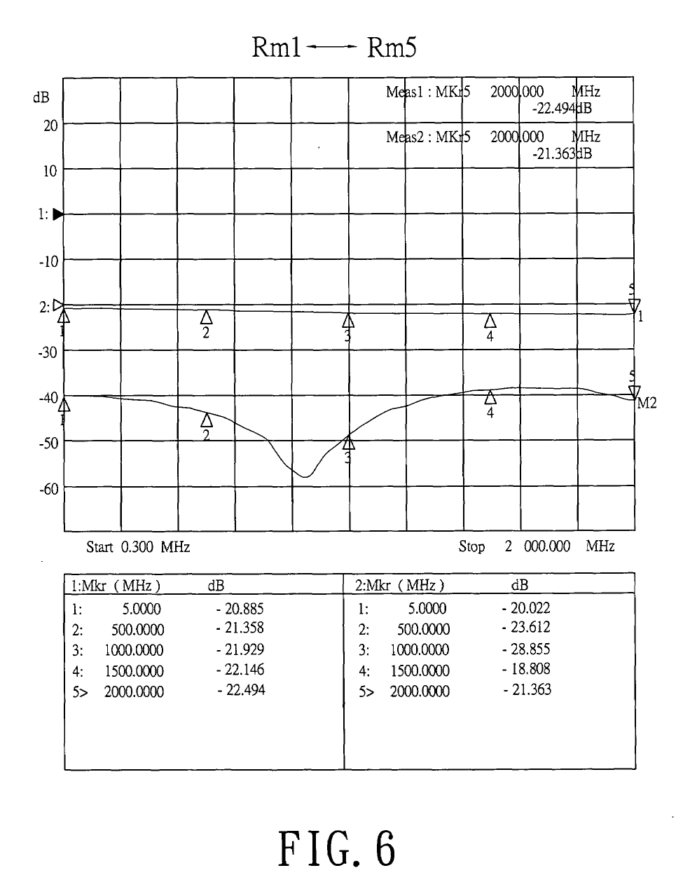

With this structure, after the connection terminals (11) are connected to a plurality of televisions or a variety of digital multimedia equipments, the signal characteristic measured by each connection terminal (11) is inspected by RF Network Analyzer. Referring to FIG. 6 showing a characteristic curve of the present invention by connecting a first connection terminal [Rm1] with a fifth connection terminal [Rm5], the Meas1 measured in the segment starting from 0.3 MHz to 2000 MHz in the X-axis direction representing the bandwidth is respectively: −20.885 db at Mkr1 of 5 MHz, −21.358 db at Mkr2 of 500 MHz, −21.929 db at MKr3 of 1000 MHz, −22.146 db at Mkr4 of 1500 MHz, −22.494 db at Mkr5 of 2000 MHz, such that the insertion loss can be adjusted according to demand, i.e., the attenuation value is adjustable. No matter whether signals is inputted from the first connection terminal [Rm1] or the fifth connection terminal [Rm5], the curve is relatively flat, i.e., excellent characteristic curve can still be obtained at higher frequency, when duplex signal transmission is conducted. Thus, more stable signal distribution and anti-interference features can be obtained in duplex signal transmission. The Meas2 is respectively: −20.022 db at Mkr1 of 5 MHz, −23.612 db at Mkr2 of 500 MHz, −28.855 db at MKr3 of 1000 MHz, −18.808 db at Mkr4 of 1500 MHz, −21.363 db at Mkr5 of 2000 MHz, showing the return loss at each Mrk point is below −18 db. This means that the present invention has excellent return loss characteristic value during duplex signal transmission.

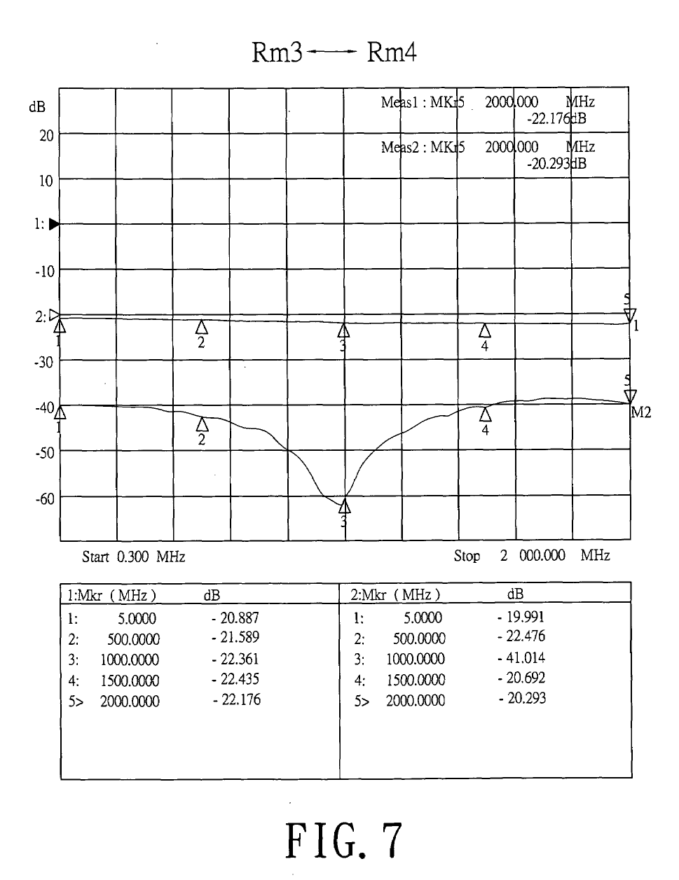

Further, referring to FIG. 7 showing the characteristic curve of the present invention by connecting a third connection terminal [Rm3] with a fourth connection terminal [Rm4], the Meas1 measured in the segment starting from 0.3 MHz to 2000 MHz in the X-axis direction representing the bandwidth is respectively: −20.887 db at Mkr1 of 5 MHz, −21.589 db at Mkr2 of 500 MHz, −22.361 db at MKr3 of 1000 MHz, −22.435 db at Mkr4 of 1500 MHz, −22.176 db at Mkr5 of 2000 MHz. Assuming the third connection terminal [Rm3] is connected to a coaxial cable for inputting signals, and each of the rest connection terminals (11) is the branch connection port assigned to each client end. When duplex signal transmission is conducted on the fourth connection terminal [Rm4], the curve is relatively flat, i.e., excellent characteristic curve can still be obtained at higher frequency. Thus, more stable signal distribution and anti-interference features can be obtained in duplex signal transmission conducted on the third connection terminal [Rm3] and the fourth connection terminal [Rm4]. The Meas2 is respectively: −19.991 db at Mkr1 of 5 MHz, −22.476 db at Mkr2 of 500 MHz, −41.014 db at MKr3 of 1000 MHz, −20.692 db at Mkr4 of 1500 MHz, −20.293 db at Mkr5 of 2000 MHz, showing the return loss at each Mrk point is below −18 db. This means that the present invention has excellent return loss characteristic value in duplex signal transmission.

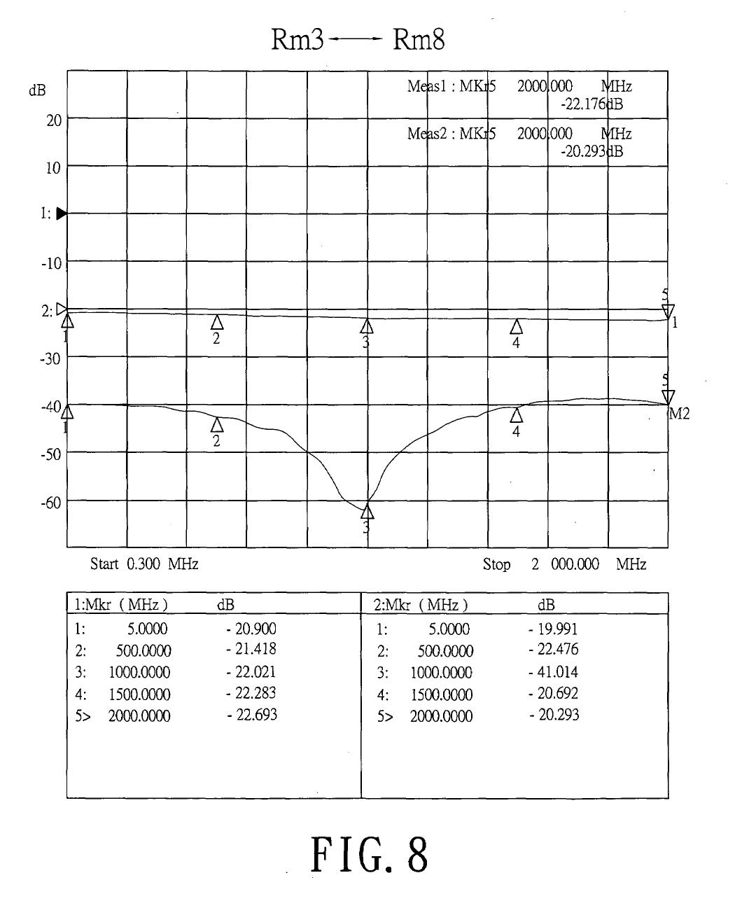

Furthermore, referring to FIG. 8 showing the characteristic curve of the present invention by connecting a third connection terminal [Rm3] with a eighth connection terminal [Rm8], the Meas1 measured in the segment starting from 0.3 MHz to 2000 MHz in the X-axis direction representing the bandwidth is respectively: −20.900 db at Mkr1 of 5 MHz, −21.418 db at Mkr2 of 500 MHz, −22.021 db at MKr3 of 1000 MHz, −22.283 db at Mkr4 of 1500 MHz, −22.693 db at Mkr5 of 2000 MHz. The third connection terminal [Rm3] is similarly connected to a coaxial cable for inputting signals. When duplex signal transmission is conducted on the eighth connection terminal [Rm8] assigned to client end, the curve is relatively flat, i.e., excellent characteristic curve can still be obtained at higher frequency. Thus, more stable signal distribution and anti-interference features can be obtained in duplex signal transmission. The Meas2 is respectively: −19.991 db at Mkr1 of 5 MHz, −22.476 db at Mkr2 of 500 MHz, −41.014 db at MKr3 of 1000 MHz, −20.692 db at Mkr4 of 1500 MHz, −20.293 db at Mkr5 of 2000 MHz, showing the return loss at each Mrk point is below −18 db. This means that the present invention has excellent return loss characteristic value in duplex signal transmission conducted between any two connection terminals (11).

The abovementioned embodiment and drawings are not intended to restrict the scope of the present invention. Appropriate variations and modifications made by the person having ordinary skill in the art without departing from the spirit and scope of the present invention are still regarded to be further embodiments of the present invention.

Based on the foregoing, the multimedia network splitter of the present invention has the following advantages when comparing with the structure of conventional stuff.
1. Inasmuch as the present invention has a plurality of connection terminals provided on the housing and the connection terminals are connected with matching circuits formed by attenuation circuits and microstrips and are connected to form a radially spaced arrangement after properly matching, after the connection terminals are connected to a plurality of televisions or a variety of digital multimedia equipments by coaxial cables, better flatness of frequency bandwidth and wider extended bandwidth can be obtained such that the signals can be evenly distributed among the networks linked between the terminals in use. Furthermore, the insertion loss, i.e., the attenuation value can be adjusted according to demand, and better return loss feature is obtained so as to reach more stable signal distribution and anti-interference characteristics during duplex signal transmission. Therefore, the convenience in its total availability can be intensified.
2. The present invention has a plurality of connection terminals provided on the housing such that after the connection of one of the connection terminals to the coaxial cable of server end, the rest of the connection terminals are connected respectively to a plurality of televisions or a variety of digital multimedia equipments of server end. This can avoid signal distortion during duplex signal transmission caused by using a number of splitters for the connection to a plurality of televisions or a variety of digital multimedia equipments. Especially, in the case of mansion having a mass of residence, each client premise equipment can connected to each connection terminal simultaneously without the need of passing through a number of splitters as prior art so that signal distortion can be effectively prevented during duplex signal transmission.

Summing up above, the embodiment of the multimedia network splitter of this invention can reach expected effectiveness, and the specific structure disclosed herein is not only unprecedented in the same category of product but also not open to the public before application.

What is claimed is:

1. A multimedia network splitter, wherein it comprises a housing, a plurality of connection terminals provided at the outer edge of the housing and a circuit board provided in the interior of the housing; corresponding to the connection terminals on the housing, a plurality of radially spaced matching circuits are provided on the circuit board, each said matching circuit is formed by a T shaped attenuation circuit, formed by a third resistor in parallel connection between a first resistor and a second resistor both in horizontal arrangement, in cooperation with a microstrip; one end of each matching circuit is connected to the connection terminal on said housing, and the other end is connected with the other attenuation circuit together to the center node of said circuit board; each matching circuit is to be properly matched on the circuit board.

2. A multimedia network splitter as claimed in claim 1, wherein said housing is octagonal and each connection terminal is disposed on the upper end surface of said housing.

3. A multimedia network splitter as claimed in claim 1, wherein said housing is rectangular and each connection terminal is disposed on the outside end surface of said housing.

4. A multimedia network splitter, wherein it comprises a housing), a plurality of connection terminals provided at the outer edge of the housing and a circuit board provided in the interior of the housing; corresponding to the connection terminals on the housing, a plurality of radially spaced matching circuits are provided on the circuit board, each said matching circuit is formed by a T shaped attenuation circuit, formed by a third resistor in connection between a first resistor and a second resistor both in vertical arrangement, in cooperation with a microstrip; one end of each matching circuit is connected to the connection terminal on said housing, and the other end is connected with the other attenuation circuit together to the center node of said circuit board; each matching circuit is to be properly matched on the circuit board.

5. A multimedia network splitter as claimed in claim 4, wherein said housing is octagonal and each connection terminal is disposed on the upper end surface of said housing.

6. A multimedia network splitter as claimed in claim 4, wherein said housing is rectangular and each connection terminal is disposed on the outside end surface of said housing.
